(19) United States
(12) Patent Application Publication
(10) Pub. No.: US 2017/0159689 A1
(43) Pub. Date: Jun. 8, 2017

(54) RATCHET CYLINDER WITH STRENGTHENED STRUCTURE FOR A BICYCLE

(71) Applicant: Te-Yao HSIEH, Taichung City (TW)

(72) Inventor: Te-Yao HSIEH, Taichung City (TW)

(21) Appl. No.: 14/963,192

(22) Filed: Dec. 8, 2015

(51) Int. Cl. F16B 9/02; F16D 41/24; B62M 9/10

(52) U.S. Cl. CPC F16B 9/02; B62M 9/10; F16D 41/24

(57) ABSTRACT

A ratchet cylinder with strengthened structure for a bicycle includes at least one anti-collision member which is disposed in the positioning grooves formed on an outer peripheral surface of the ratchet cylinder to press against the edge of the engaging ribs, and have rigidity higher than the engaging ribs. The anti-collision members will take the pushing force produced by the sprocket wheel, so as to prevent the engaging ribs from being damaged by the pushing force produced by the sprocket wheel. As a result, the structure strength of the ratchet cylinder and the engaging ribs are reinforced, and the maintenance cost can also be reduced.

### BACKGROUND OF THE INVENTION

### Field of the Invention

The present invention relates to a ratchet cylinder of a bicycle, and more particularly to a ratchet cylinder with strengthened structure for a bicycle.

### Related Prior Art

A conventional ratchet cylinder of a bicycle is normally provided around an outer peripheral surface thereof with a plurality of engaging ribs to fix the sprocket wheel, and then the sprocket wheel rotates to drive the chain to move. The existing ratchet cylinder is usually made of aluminum for the purpose of integrity and lightweight. However, the sprocket wheel is normally made of iron, and has a higher rigidity than the ratchet cylinder. When the sprocket wheel is engaged with the ratchet cylinder, the ratchet cylinder cannot take the pushing force generated by the sprocket wheel, and the engaging ribs on the ratchet cylinder are likely to be slightly deformed. As a result, the ratchet cylinder is unable to tightly mesh with the sprocket wheel, and has to be replaced or repaired, thus increasing the maintenance cost.

The present invention has arisen to mitigate and/or obviate the afore-described disadvantages.

### SUMMARY

The present invention is aimed at providing a ratchet cylinder with strengthened structure for a bicycle, wherein at least one anti-collision member is abutted against the lateral edge of the engaging ribs of the ratchet cylinder to take a pushing force produced by rotation of the sprocket wheel, and to prevent damage to the engaging ribs.

To achieve the above objective, a ratchet cylinder with strengthened structure for a bicycle, comprises: a ratchet cylinder fixed to a sprocket wheel and provided with a plurality of engaging ribs around an outer peripheral surface thereof, a positioning groove being adjacent to a lateral edge of each of the engaging ribs and including at least one positioning hole; and at least one anti-collision member disposed in a corresponding one of the positioning grooves, and having at least one positioning portion inserted in the positioning hole, so that the anti-collision member is abutted against the lateral edge of a corresponding one of the engaging ribs to take a pushing force produced by rotation of the sprocket wheel, and prevent damage to the engaging ribs.

Preferably, three said anti-collision members are equidistantly disposed in the positioning grooves and abutted against the lateral edge of the engaging ribs.

Preferably, each of the positioning grooves is located at an upstream side of the respective engaging ribs in a rotation direction of the sprocket wheel.

### BRIEF DESCRIPTION OF THE DRAWINGS

FIG. 1 is an exploded view of a ratchet cylinder with strengthened structure for a bicycle in accordance with the preferred embodiment of the present invention;

FIG. 2 is an assembly view of the ratchet cylinder with strengthened structure for a bicycle in accordance with the preferred embodiment of the present invention;

FIG. 3 is another exploded view of the ratchet cylinder with strengthened structure for a bicycle in accordance with the preferred embodiment of the present invention;

FIG. 4 is another assembly view of the ratchet cylinder with strengthened structure for a bicycle in accordance with the preferred embodiment of the present invention;

FIG. 5 shows that the ratchet cylinder with strengthened structure for a bicycle in accordance with the preferred embodiment of the present invention is fixed to a sprocket wheel; and

FIG. 6 is a cross sectional view showing that the ratchet cylinder with strengthened structure for a bicycle in accordance with the preferred embodiment of the present invention is fixed to a sprocket wheel.

### DETAILED DESCRIPTION

The present invention will be clearer from the following description when viewed together with the accompanying drawings, which show, for purpose of illustrations only, the preferred embodiment in accordance with the present invention.

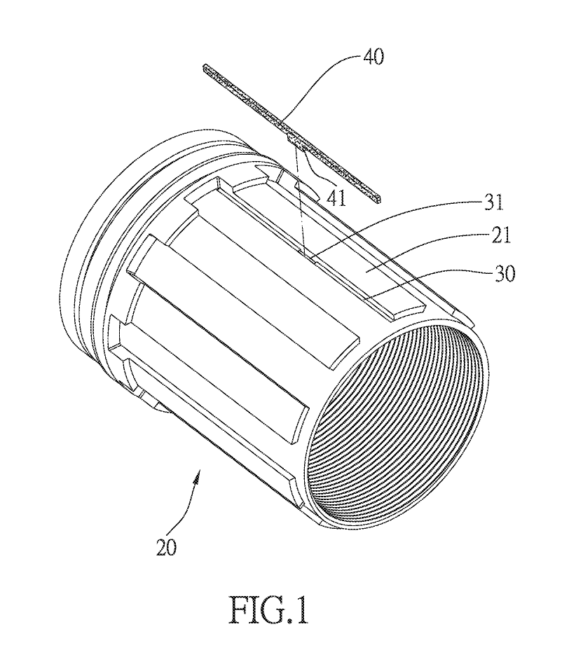

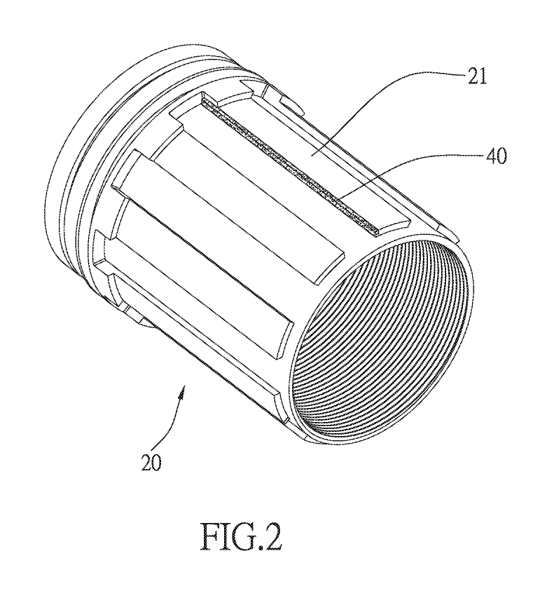

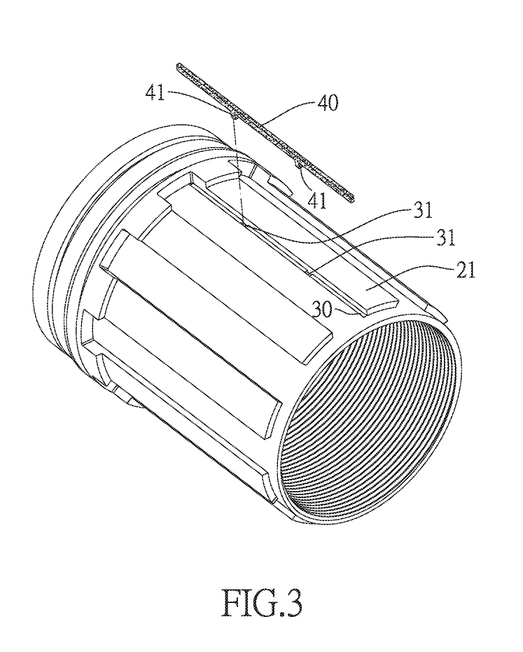

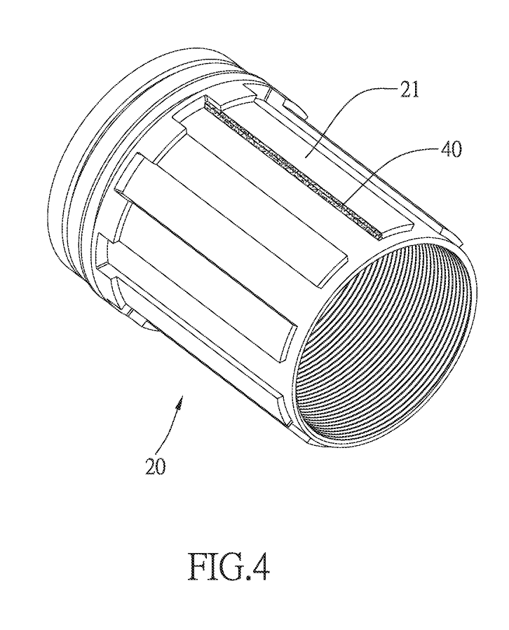

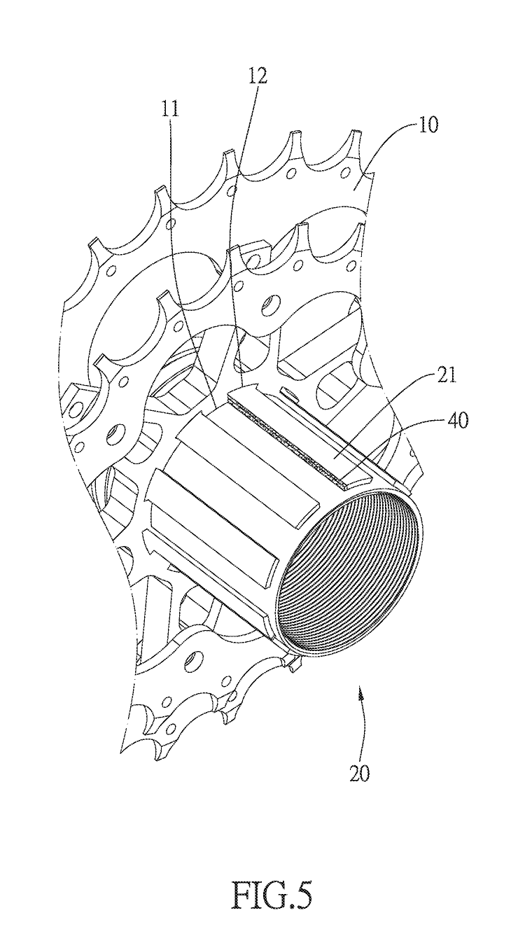

Referring to FIGS. 1-6, a ratchet cylinder with strengthened structure for a bicycle in accordance with the preferred embodiment of the present invention comprises a ratchet cylinder 20 to be fixed to a sprocket wheel 10 of the bicycle.

The ratchet cylinder 20 is provided with a plurality of engaging ribs 21 around an outer peripheral surface thereof. Adjacent to a lateral edge of each of the engaging ribs 21 is a positioning groove 30 which includes at least one positioning hole 31, and each of the positioning grooves 30 is located at an upstream side of the respective engaging ribs 21 in the rotation direction of the sprocket wheel 10.

The sprocket wheel 10 is provided with a central assembling hole 11 and a plurality of assembling grooves 12 around an inner surface of the central assembling hole 11, and the assembling grooves 12 correspond in position and number to the engaging ribs 21.

The present invention is characterized in that it further comprises at least one anti-collision member 40 with a higher rigidity than the ratchet cylinder 20. The anti-collision member 40 is provided with at least one positioning portion 41 which is aligned with the positioning hole 31 of the positioning grooves 30. The anti-collision member 40 is disposed in an arbitrary one of the positioning grooves 30, and has the positioning portion 41 inserted in the positioning hole 31, so that the anti-collision member 40 is abutted against the engaging ribs 21. The engaging ribs 21 of the ratchet cylinder 20 are engaged in the assembling grooves 12 of the sprocket wheel 10, so as to fix the sprocket wheel 10 to the ratchet cylinder 20.

Each of the positioning grooves 30 can be provided with one or two positioning holes 31, and the number of the positioning portions 41 of the anti-collision member 40 is equal to the number of the positioning holes 31 of each of the positioning grooves 30. The anti-collision member 40 is positioned in the positioning grooves 30 by the positioning portion 41.

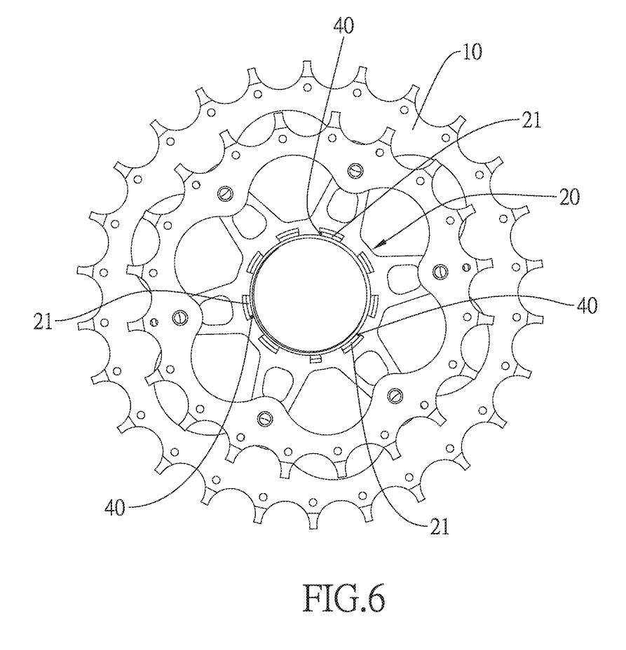

Referring then to FIG. 6, in this embodiment, the structure can be strengthened to different degrees as desired or based on different functions of a bicycle. For example, the ratchet cylinder of this embodiment can be provided with three anti-collision members 40 which are equidistantly disposed in the positioning grooves 30, so that the anti-collision members 40 are abutted against the edge of the engaging ribs 21 to reinforce the structure strength of the engaging ribs 21 and the ratchet cylinder 20.

Since the anti-collision members 40 are disposed in the positioning grooves 30 to press against the edge of the engaging ribs 21, and have a rigidity higher than the engaging ribs 21, when a user pedals the bicycle and causes rotation of the sprocket wheel 10, the anti-collision members 40 will take the pushing force produced by the sprocket wheel 10, so as to prevent the engaging ribs 21 from being damaged by the pushing force produced by the sprocket wheel 10. As a result, the structure strength of the ratchet cylinder 20 and the engaging ribs 21 are further reinforced, and the maintenance cost can also be reduced, since the ratchet cylinder does not have to be replaced or repaired.

While we have shown and described various embodiments in accordance with the present invention, it is clear to those skilled in the art that further embodiments may be made without departing from the scope of the present invention.

What is claimed is:

1. A ratchet cylinder with strengthened structure for a bicycle, comprising:
a ratchet cylinder fixed to a sprocket wheel and provided with a plurality of engaging ribs around an outer peripheral surface thereof, a positioning groove being adjacent to a lateral edge of each of the engaging ribs and including at least one positioning hole; and
at least one anti-collision member disposed in a corresponding one of the positioning grooves, and having at least one positioning portion inserted in the positioning hole, so that the anti-collision member is abutted against the lateral edge of a corresponding one of the engaging ribs to take a pushing force produced by rotation of the sprocket wheel, and prevent damage to the engaging ribs.

2. The ratchet cylinder as claimed in claim 1, wherein each of the positioning grooves includes one said positioning hole, and the anti-collision member is also provided with one said positioning portion.

3. The ratchet cylinder as claimed in claim 1, wherein each of the positioning grooves includes two said positioning holes and the anti-collision member is also provided with two said positioning portions.

4. The ratchet cylinder as claimed in claim 1, wherein three said anti-collision members are equidistantly disposed in the positioning grooves and abutted against the lateral edge of the engaging ribs.

5. The ratchet cylinder as claimed in claim 1, wherein the anti-collision member has a higher rigidity than the ratchet cylinder.

6. The ratchet cylinder as claimed in claim 1, wherein the sprocket wheel is provided with an assembling hole, and a plurality of assembling grooves around an inner surface of the assembling hole to engage with the engaging ribs.

7. The ratchet cylinder as claimed in claim 1, wherein each of the positioning grooves is located at an upstream side of the respective engaging ribs in a rotation direction of the sprocket wheel.
